(19) United States
(12) Patent Application Publication
(10) Pub. No.: US 2005/0010705 A1
(43) Pub. Date: Jan. 13, 2005

(54) Computer apparatus and method for autonomically detecting system reconfiguration and maintaining persistent I/O bus numbering

(75) Inventors: David Alan Bailey, Kasson, MN (US); Gregory Michael Nordstrom, Pine Island, MN (US); Thomas Rembert Sand, Rochester, MN (US)

Correspondence Address: MARTIN & ASSOCIATES, LLC;IBM INTELLECTUAL PROPERTY LAW DEPARTMENT, DEPARTMENT 917, BUILDING 006-1, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 10/616,683

(22) Filed: Jul. 10, 2003

(51) Int. Cl. G06F 13/00

(52) U.S. Cl. 710/104

(57) ABSTRACT

In a computer system that includes multiple physical enclosures, an enclosure includes a non-volatile memory that includes bus numbering information for its own buses as well as bus numbering information for one or more of its neighbors. In the preferred implementation, all enclosures include a non-volatile memory that includes bus numbering information for its own buses and for both of its neighbors. This creates a distributed database of the interconnection topology for the computer system. Because an enclosure contains bus numbering information about its neighbor enclosure(s), the bus numbers for the buses in the physical enclosures are made persistent across numerous different system reconfigurations. The preferred embodiments also include a bus number manager that reads the non-volatile memories in the physical enclosures during initial program load (i.e., boot) that reconstructs the interconnection topology from the information read from the non-volatile memories, and that assigns bus numbers to the buses according to the derived interconnection topology.

### BACKGROUND OF THE INVENTION

1. Technical Field

This invention generally relates to data processing, and more specifically relates to the assignment of bus numbers in a computer system that has multiple buses in multiple physical enclosures.

2. Background Art

Since the dawn of the computer age, computer systems have evolved into extremely sophisticated devices that may be found in many different settings. Computer systems typically include a combination of hardware (e.g., semiconductors, circuit boards, etc.) and software (e.g., computer programs). As advances in semiconductor processing and computer architecture push the performance of the computer hardware higher, more sophisticated computer software has evolved to take advantage of the higher performance of the hardware, resulting in computer systems today that are much more powerful than just a few years ago.

Large computer systems typically include several different physical enclosures. For example, one enclosure may include system processors and memory, while other enclosures include various different input/output (I/O) devices, such as hard disk drives, networking devices, etc. In known computer systems that include multiple physical enclosures, bus numbers for each enclosure are written to a non-volatile memory within the enclosure. This allows the system to know what bus numbers to assign during initial program load (i.e., boot). The non-volatile memory is read, and the bus numbers indicated in the non-volatile memory are then assigned to the buses in the enclosure.

One problem with the known method of storing bus numbers in non-volatile memory within an enclosure occurs when the system is reconfigured. For example, if hardware in an I/O tower that includes the non-volatile memory is upgraded, the non-volatile memory will not have any information about the bus number assignments within the enclosure. As a result, the prior art assigns new bus numbers to the buses in the enclosure, even though those buses were assigned other numbers before the hardware upgrade. This leaves the previously-used bus numbers unused and unavailable for use. Because the numbers assigned to buses in the enclosure have changed, a system administrator will have to reconfigure the system to recognize the new bus number. This process is no simple task, and requires a highly skilled system administrator to perform the manual reconfiguration so the computer system runs properly after reconfiguration. This requires that a skilled system administrator be present each time a system reconfiguration is performed. However, sometimes a system is dynamically “reconfigured” by a hardware or cabling failure.

Without a way to assign bus numbers that are persistent and can be automatically reassigned after a variety of different types of system reconfiguration, the computer industry will continue to suffer from expensive and error-prone manual updates when a system reconfiguration occurs.

### DISCLOSURE OF INVENTION

In a computer system that includes multiple physical enclosures, an enclosure includes a non-volatile memory that includes bus numbering information for its own buses as well as bus numbering information for one or more of its neighbors. In the preferred implementation, all enclosures include a non-volatile memory that includes bus numbering information for its own buses and for both of its neighbors. This creates a distributed database of the interconnection topology for the computer system. Because an enclosure contains bus numbering information about its neighbor enclosure(s), the bus numbers for the buses in the physical enclosures are made persistent across numerous different system reconfigurations. The preferred embodiments also include a bus number manager that reads the non-volatile memories in the physical enclosures during initial program load (i.e., boot) that reconstructs the interconnection topology from the information read from the non-volatile memories, and that assigns bus numbers to the buses according to the derived interconnection topology.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is a block diagram of a prior art computer system that includes a central electronics complex (CEC) and four I/O towers;

FIG. 2 is a more detailed block diagram of prior art computer system 100 in FIG. 1 showing some of the internal components in the CEC and each I/O tower;

FIG. 3 is a block diagram of the prior art computer system in FIG. 1 after hardware that includes the non-volatile memory has been upgraded in Tower C;

FIG. 4 is a flow diagram of a prior art method for a bus number manager to assign bus numbers during initial program load;

FIG. 5 is a block diagram of the prior art computer system in FIG. 3 after performing method 400 in FIG. 4 to assign bus numbers;

FIG. 6 is a block diagram of a computer system in accordance with the preferred embodiments that includes a central electronics complex (CEC) and four I/O towers;

FIG. 7 is a block diagram of the computer system in FIG. 6 after hardware that includes the non-volatile memory has been upgraded in Tower C; and

FIG. 8 is a flow diagram of a method in accordance with the preferred embodiments for assigning bus numbers during initial program load.

### BEST MODE FOR CARRYING OUT THE INVENTION

### 1. OVERVIEW OF PRIOR ART

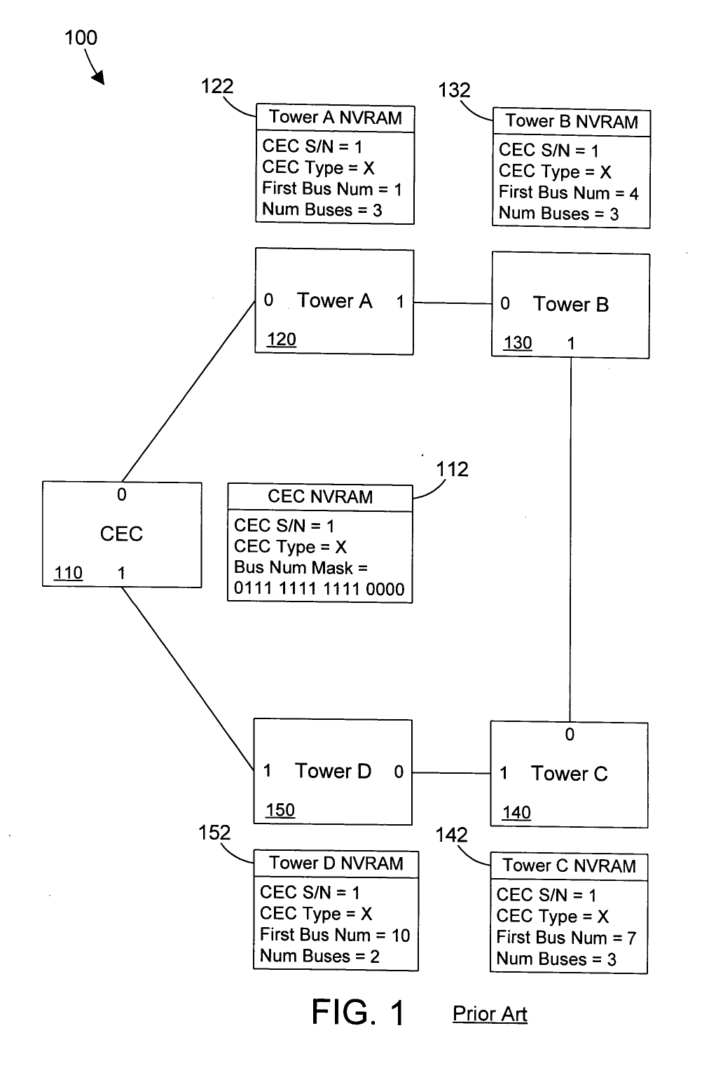

An understanding of the prior art helps to more fully understand the preferred embodiments of the present invention. FIG. 1 shows a sample prior art computer system 100 that includes a central electronics complex (CEC) 110 and four I/O towers 120, 130, 140 and 150. The CEC 110 includes two ports labeled 0 and 1 for connection to I/O towers. In similar fashion, each I/O tower includes two ports labeled 0 and 1 for connection to the CEC and/or other I/O towers. In the specific configuration shown in FIG. 1, the CEC 110 and four towers 120, 130, 140 and 150 are arranged in a loop configuration.

Each I/O tower includes a non-volatile memory. Non-volatile Random Access Memories (NVRAMs) are shown in FIG. 1 as one specific type of non-volatile memory that could be used. Tower A 120 contains NVRAM 122; Tower B 130 contains NVRAM 132; Tower C 140 contains NVRAM 142; and Tower D 150 contains NVRAM 152. Each tower NVRAM contains the serial number of the CEC, the CEC type, the first bus number assigned in that tower, and the number of buses in that tower. Thus, we see from the information stored in tower A NVRAM 122 that Tower A 120 has three buses (Num Buses=3), and the first of those buses is number one (First Bus Num=1). The bus numbering scheme assumes a range of contiguous bus numbers in a tower. This means the three buses in Tower A 120 are assigned bus numbers 1, 2 and 3. Tower B NVRAM 132 indicates that Tower B 130 has 3 buses, and the first of those buses is number 4. This means the three buses in Tower B 130 are assigned bus numbers 4, 5 and 6. Tower C NVRAM 142 indicates that Tower C 140 has 3 buses, and the first of those buses is number 7. This means the three buses in Tower C 140 are assigned bus numbers 7, 8 and 9. Tower D NVRAM 152 indicates that Tower D 150 has 2 buses, and the first of those buses is number 10. This means the two buses in Tower D 150 are assigned bus numbers 10 and 11.

The CEC 110 also includes an NVRAM 112 that includes the serial number of the CEC, the CEC type, and a bus number mask. The bus number mask is a string of bits that each represent a bus number. When a bus number has been assigned, its corresponding bit is set to one in the bus number mask. The left-most bit represents bus number zero, the next bit represents bus number one, etc. Thus, with buses 1-11 assigned to the towers as described in the preceding paragraph, we see that the bus number mask has bits 1-11 set to one, with bits 0 and bits greater than 11 all set to zero, indicating that bus numbers 1-11 have been assigned.

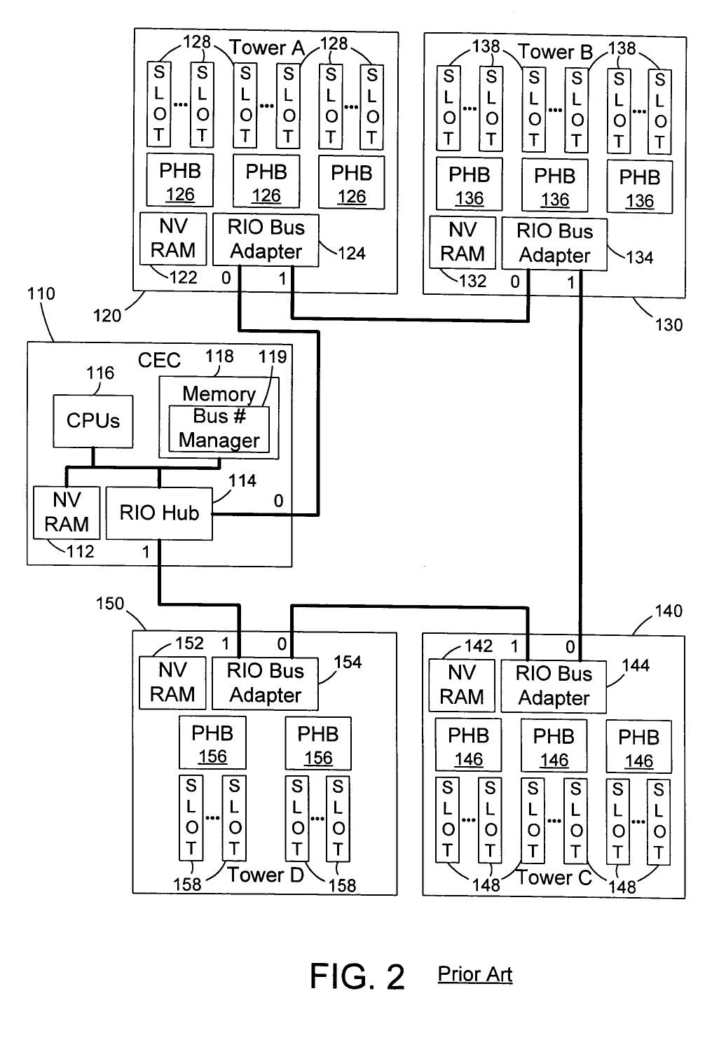

More details of computer system 100 are shown in the block diagram of FIG. 2. CEC 110 preferably includes one or more CPUs 116, memory 118, NVRAM 112, and a remote I/O (RIO) hub 114. Each CPU 116 may be constructed from one or more microprocessors and/or integrated circuits. CPUs 116 execute program instructions stored in memory 118. Memory 118 stores programs and data that CPUs 116 may access. Memory 118 preferably includes a bus number manager 119 that is executed by one or more CPUs 116 during initial program load to assign bus numbers to buses in the system. NVRAM 112 contains information that identifies the serial number and type of CEC, and that includes the bus number mask, as shown in FIG. 1. RIO hub 114 provides two ports labeled 0 and 1 for connecting the CEC 110 to one or more I/O towers.

Each I/O tower includes a remote I/O (RIO) bus adapter that has two ports labeled 0 and 1 for connecting to the CEC and/or other towers. Each tower includes one or more PCI host bridges coupled to the RIO bus adapter. The PCI host bridge within a tower is what is assigned a persistent bus number that is stored in non-volatile memory. Each PCI host bridge may be coupled to one or more I/O slots that may each receive a compatible I/O adapter. Tower A 120 thus includes an RIO bus adapter 124 that has port 0 coupled to port 0 of the RIO hub 114 in CEC 110, and that has port 1 coupled to port 0 of the RIO bus adapter 134 in Tower B 130. The RIO bus adapter 124 is coupled to three PCI host bridges 126, which correspond to the three numbered buses in Tower A 120. Each PCI host bridge 126 may be coupled to one or more I/O slots 128, which may each contain a compatible I/O adapter.

The configuration of Tower B 130 is similar to the configuration for Tower A 120. Tower B 130 has an RIO bus adapter 134 coupled to three PCI host bridges 136 that correspond to the numbered buses in Tower B 130. PCI host bridges 136 are coupled to slots 138. Tower B also includes NVRAM 132, which contains the contents shown in FIG. 1. The configuration of Tower C 140 is also similar to the configuration for Towers A 120 and B 130. Tower C 140 has an RIO bus adapter 144 coupled to three PCI host bridges 146 that correspond to the numbered buses in Tower C 140. PCI host bridges 146 are coupled to slots 148. Tower C also includes NVRAM 142, which contains the contents shown in FIG. 1.

The configuration of Tower D 150 differs from the other towers, because in this specific example Tower D only has two buses instead of the three buses in each of Towers A 120, B 130 and C 140. Tower D 150 has an RIO bus adapter 154 coupled to two PCI host bridges 156 that correspond to the numbered buses in Tower D 150. PCI host bridges 156 are coupled to slots 158. Tower D also includes NVRAM 152, which contains the contents shown in FIG. 1.

Note that the ports of RIO hub 114 in CEC and RIO bus adapters 124, 134, 144 and 154 are labeled 0 and 1, and correspond to the connections with the same labels in FIG. 1. This connection topology is a loop because it starts at one port of the CEC and loops through each tower back to the other port of the CEC.

The specific configuration in FIG. 2 shows the use of PCI buses in a computer system. Note, however, that the preferred embodiments are not limited to PCI buses, but expressly extend to any type of bus, whether currently known or developed in the future, that requires a unique bus number to be assigned.

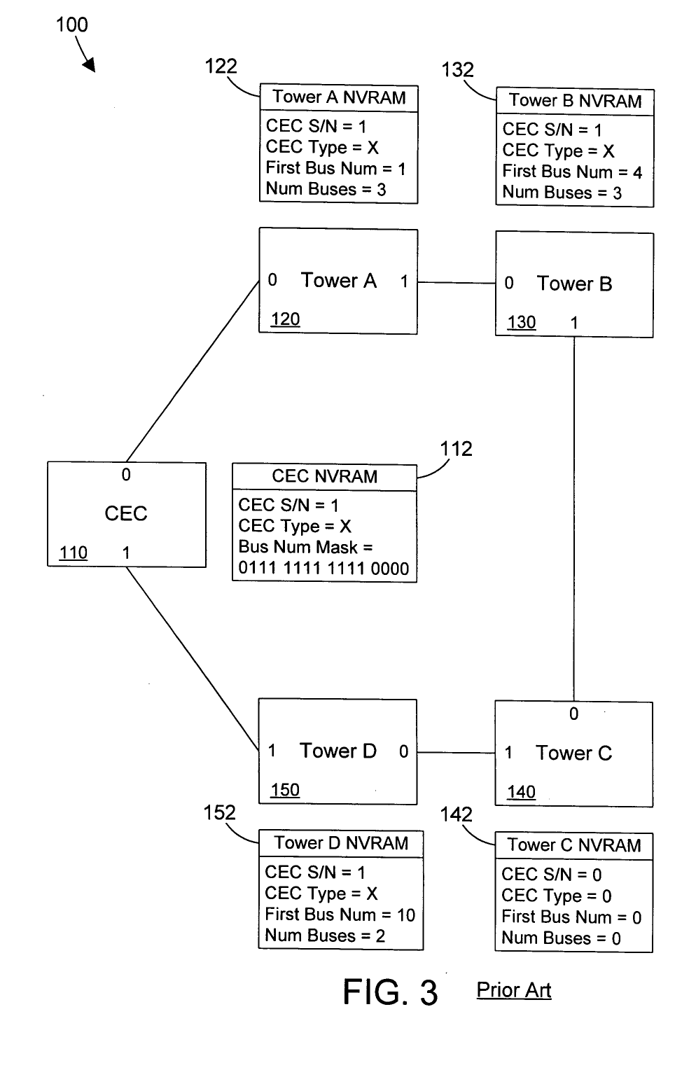

Now we assume that computer system 100 in FIG. 1 is upgraded. We assume the computer system 100 is powered down, and the hardware in Tower C 140 that includes the NVRAM 142 is replaced. As a result, the contents of NVRAM 142 are zeroes, as shown in FIG. 3. We further assume that the other hardware in Tower C 140 remains unaffected in other words, Tower C 140 still has the same configuration shown in FIG. 2. The difference is that the tower C NVRAM 142 does not contain valid bus numbering information.

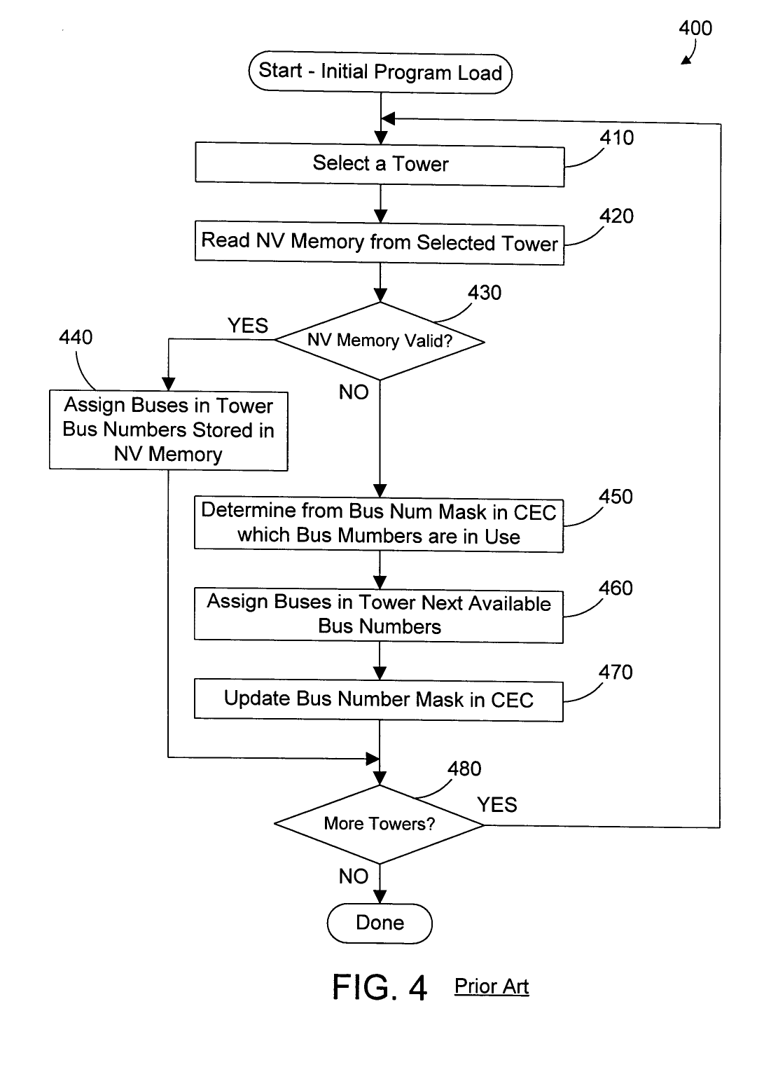

Each time computer system 100 powers up, it performs what is referred to herein as an Initial Program Load (IPL), which is essentially a boot sequence of events. During IPL, a bus number manager (119 in FIG. 2) assigns unique bus numbers to the buses in all of the I/O towers. Referring to FIG. 4, method 400 represents steps performed in the prior art by bus number manager 119 during an initial program load to assign bus numbers. First, a tower is selected (step 410). The non-volatile memory for the selected tower is read (step 420). If the non-volatile memory is valid (step 430=YES), the buses in the tower are assigned bus numbers based on the bus numbering information read from the non-volatile memory (step 440). For non-volatile memory to be valid in step 430, the CEC serial number and type must match that CEC serial number and type recorded in the CEC NVRAM 112.

If the non-volatile memory is not valid (step 430=NO), the bus number mask in the CEC is read to determine which bus numbers are in use (step 450). The buses in the tower are then assigned the next available bus numbers (step 460). Because new bus numbers have been assigned, the bus number mask in the CEC must be updated (step 470) to reflect the newly-assigned buses. If there are more towers to process (step 480=YES), method 400 loops back to step 410 and continues until all towers have been processed (step 480=NO).

Now we apply method 400 to the computer system shown in FIG. 3. We assume that Tower A 120 is initially selected in step 410. The tower A NVRAM 122 is read (step 420), and it is determined that the data read from the tower A NVRAM 122 is valid (step 430=YES) because the CEC serial number and CEC type match the values stored in the CEC NVRAM 112. The three buses in Tower A 120 are then assigned bus numbers 1, 2 and 3 (step 440), because the data read from the tower A NVRAM 122 indicates that the first bus number is 1 and the number of buses is 3. There are more towers to process (step 480=YES), so Tower B 130 is then selected in step 410. The tower B NVRAM 132 is read (step 420), and it is determined that the data read from the tower B NVRAM 132 is valid (step 430=YES). The three buses in Tower B 130 are then assigned bus numbers 4, 5 and 6 (step 440), because the data read from the tower B NVRAM 132 indicates that the first bus number is 4 and the number of buses is 3. There are more towers to process (step 480=YES), so Tower C 140 is then selected in step 410. The tower C NVRAM 142 is read (step 420), and it is determined that the data read from the tower C NVRAM 142 is invalid (step 430=NO) because the CEC serial number and CEC type do not match the values stored in the CEC NVRAM 112. The CEC serial number and CEC type thus serve as identifiers for determining whether the contents of a tower NVRAM are valid. At this point the bus number mask in the CEC NVRAM 112 is read to determine which bus numbers to use (step 450). We see from the bus number mask in FIG. 3 that buses 1-11 are in use. The three buses in Tower C 140 are then assigned the next three available bus numbers, namely 12, 13 and 14 (step 460). The bus number mask in the CEC NVRAM 112 is then updated to reflect that bus numbers 12, 13 and 14 are now in use (step 470). There is still one more tower to process (step 480=YES), so method 400 loops back and selects Tower D 150 (step 410). The tower D NVRAM 152 is then read (step 420), and it is determined that the data read is valid (step 430=YES). The buses in Tower D 150 are assigned bus numbers 10 and 11 (step 440), because the data read from the tower D NVRAM 152 indicates that the first bus number is 10 and the number of buses is 2. There are no more towers to process (step 480=NO), so method 400 is done.

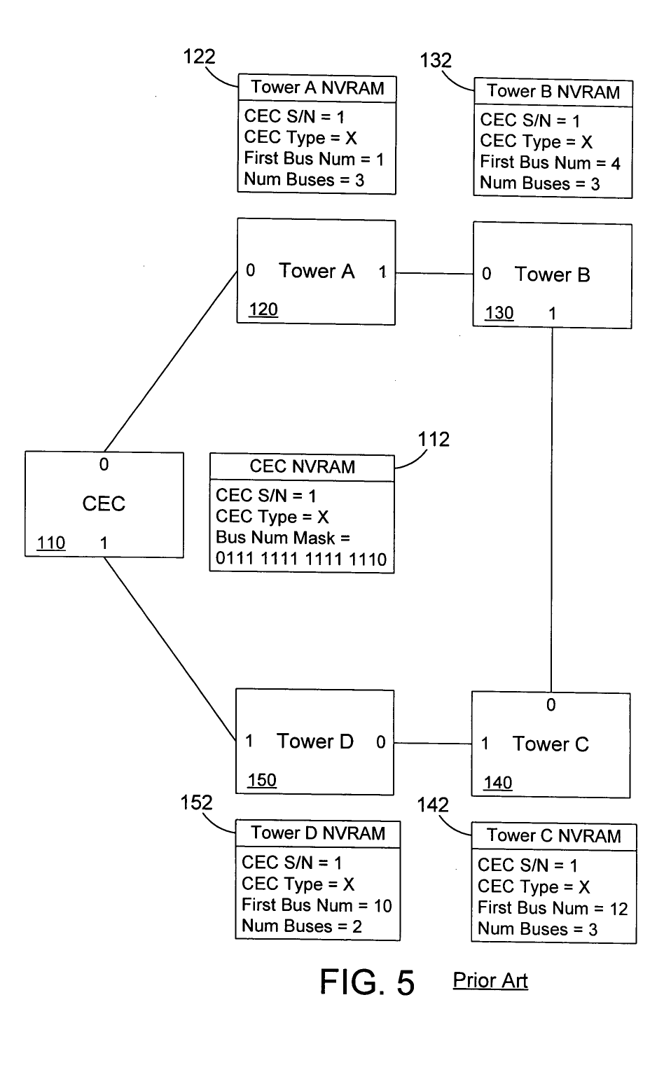

The result of performing method 400 on computer system 100 in FIG. 3 is shown in FIG. 5. The two differences between FIGS. 3 and 5 is the bus number mask in the CEC NVRAM 112 and the contents of tower C NVRAM 142. The contents of tower C NVRAM 142 have been updated to reflect the proper CEC serial number and CEC type. Because the three buses in Tower C 140 were assigned buses 12, 13 and 14, the first bus num is set to 12, and the num buses is set to 3, as shown in FIG. 5. Furthermore, because bus numbers 12, 13 and 14 are now in use, the bus number mask in the CEC NVRAM 112 has been updated to change the bits corresponding to bus numbers 12, 13 and 14 from zero to one.

The prior art method 400 has thus produced two undesirable results of the upgrade to Tower C 140. First, the buses that were formerly numbered 7, 8 and 9 in Tower C 140 have been renumbered 12, 13 and 14. This means that any system resource that wants to use the buses in Tower C 140 must be manually reconfigured to change those bus numbers from 7, 8 and 9 to 12, 13 and 14. This is a time-consuming process that must be performed by a highly-skilled system administrator. Until this manual reconfiguration is performed, the computer system 100 will not function correctly. In a planned system upgrade, a company could plan for a system administrator to be available to perform such reconfiguration so the computer system is down for a minimum of time. Note, however, that some system reconfigurations may occur as hardware fails, or as towers are rearranged in different connection topologies or orders. To address these unpredictable cases, a skilled system administrator would have to be available at all times. This is a costly and undesirable solution.

A second undesirable result is that bus numbers 7, 8 and 9 that were used in Tower C 140 before the upgrade are no longer available for use. The bus number mask was updated to reflect the assignment of new bus numbers 12, 13 and 14, but the bus number manager has no way to know whether the bus numbers 7, 8 and 9 are still present in the system but non-functional, or whether they are no longer present. In the example shown in FIGS. 1-5, the bus numbers 7, 8 and 9 were reassigned to 12, 13 and 14, making bus numbers 7, 8 and 9 unused. But the bus number manager has no idea that bus numbers 7, 8 and 9 are unused, so they remain marked as assigned in the CEC NVRAM 112. As a result, over time, there may be a relatively large number of bus numbers that are unavailable for use.

What is needed is a way to recognize that Tower C 140 has been upgraded, and to autonomically assign the old bus numbers, namely 7, 8 and 9, to the buses in Tower C 140 after the upgrade. The present invention provides just such a solution, as presented below in reference to the preferred embodiments.

### 2. DESCRIPTION OF PREFERRED EMBODIMENTS

The preferred embodiments of the present invention overcome the problems in the prior art by providing a non-volatile memory in each enclosure that stores not only bus numbering information for that enclosure, but also stores bus numbering information for the enclosure's neighbors as well. The result is a distributed database of interconnection topology for the computer system. By storing bus numbering information in each neighbor enclosure, if an enclosure is upgraded or goes down, or some other system reconfiguration occurs, the bus number manager during initial program load can read the bus numbering information in the neighbors to autonomically determine how to properly assign bus numbers to buses in the enclosure. By so doing, the preferred embodiments allow a way to perform system reconfiguration without the threat of the system not functioning correctly due to bus numbering problems.

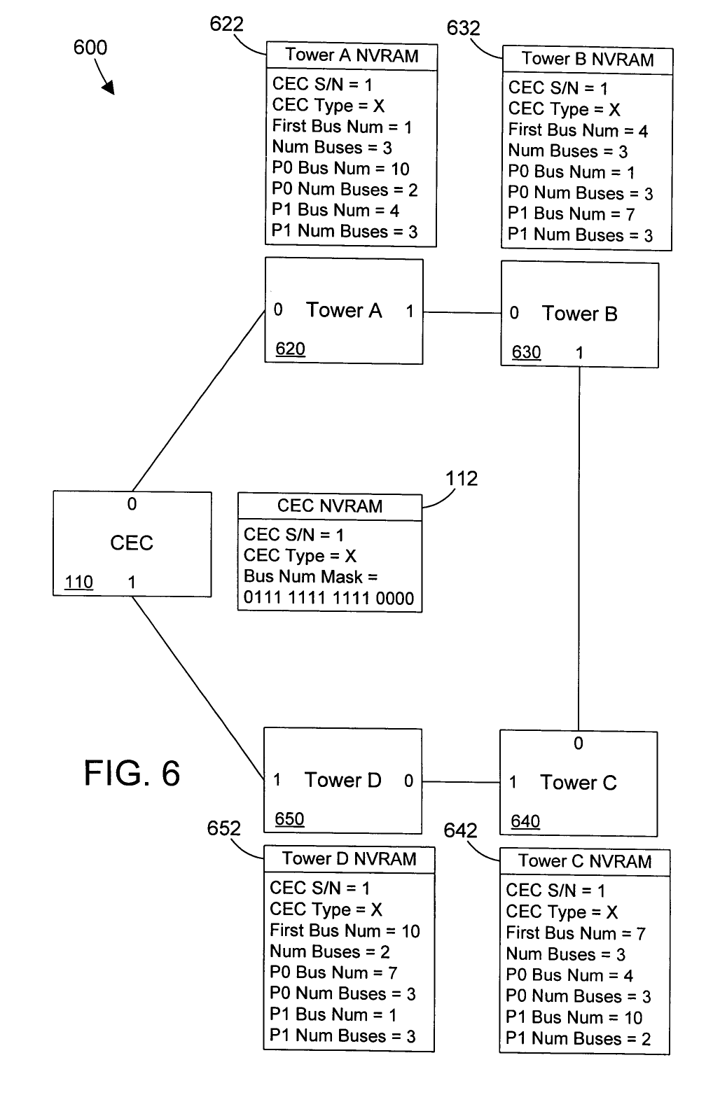

Referring to FIG. 6, a computer system 100 is similar in many respects to computer system 100 in FIG. 1. A CEC 110 is connected to four towers 620, 630, 640 and 650 in a loop as shown. CEC NVRAM 112 has not changed, and includes the CEC serial number, the CEC type, and the bus number mask. The primary difference between computer system 600 in FIG. 6 and computer system 100 in FIG. 1 is what is stored in the non-volatile memory in each I/O tower, and how the bus number manager uses that information to assign bus numbers during initial program load. In FIG. 6, the non-volatile memory in each tower contains not only bus numbering information for its own buses, but also contains bus numbering information for its neighbors as well. Thus, tower A NVRAM 622 contains the CEC serial number, CEC type, First Bus Num, and Num Buses, which is the same information shown in tower A NVRAM 122 in FIG. 2. Note, however, that tower A NVRAM 622 additionally includes a first bus number and number of buses for the two enclosures coupled to its two ports. Thus, P0 Bus Num=10 indicates that the enclosure coupled to port 0 has a starting bus number of 10. Note that CEC contains none of the type of buses that are being numbered elsewhere in the system, so the CEC is ignored, and the tower A NVRAM 622 provides the information as if its port 0 is coupled directly to port 1 of Tower D 650. Thus we see that the P0 Bus Num=10 and P0 Num Buses=2 describes the bus numbering information for Tower D 650 which is coupled through CEC 110 to port 0 of Tower A 620. In similar fashion, P1 Bus Num=4 and P1 Num Buses=3 provides bus numbering information for the neighbor coupled to port 1, namely Tower B 630. The tower B NVRAM 632 contains bus numbering information for its own buses (First Num Bus=4, Num Buses=3), and also contains bus numbering information for its neighbors, Tower A 620 (P0 Bus Num=1, P0 Num Buses=3) and Tower C 640 (P1 Bus Num=7, P1 Num Buses=3). The tower C NVRAM 642 contains bus numbering information for its own buses (First Num Bus=7, Num Buses=3), and also contains bus numbering information for its neighbors, Tower B 630 (P0 Bus Num=4, P0 Num Buses=3) and Tower D 650 (P1 Bus Num=10, P1 Num Buses=2). The tower D NVRAM 652 contains bus numbering information for its own buses (First Num Bus=10, Num Buses=3), and also contains bus numbering information for its neighbors, Tower A 620 (P1 Bus Num=1, P1 Num Buses=3) and Tower C 640 (P0 Bus Num=7, P1 Num Buses=3). In this manner, each enclosure contains in non-volatile memory bus numbering information for its neighbor enclosures as well as for its own buses.

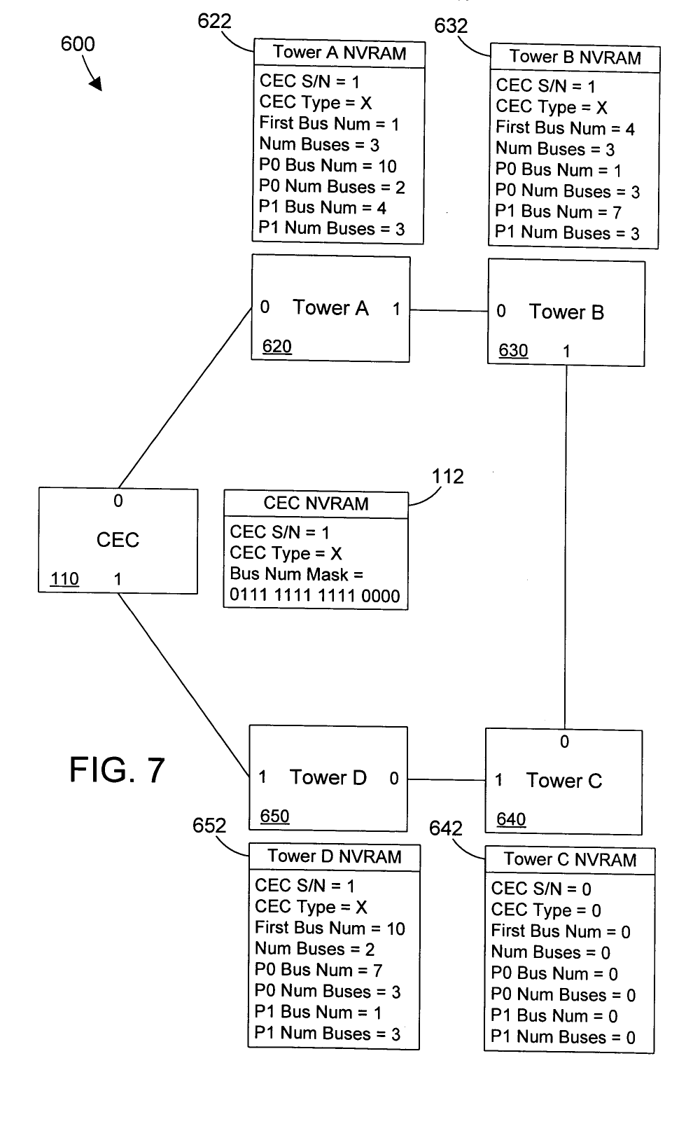

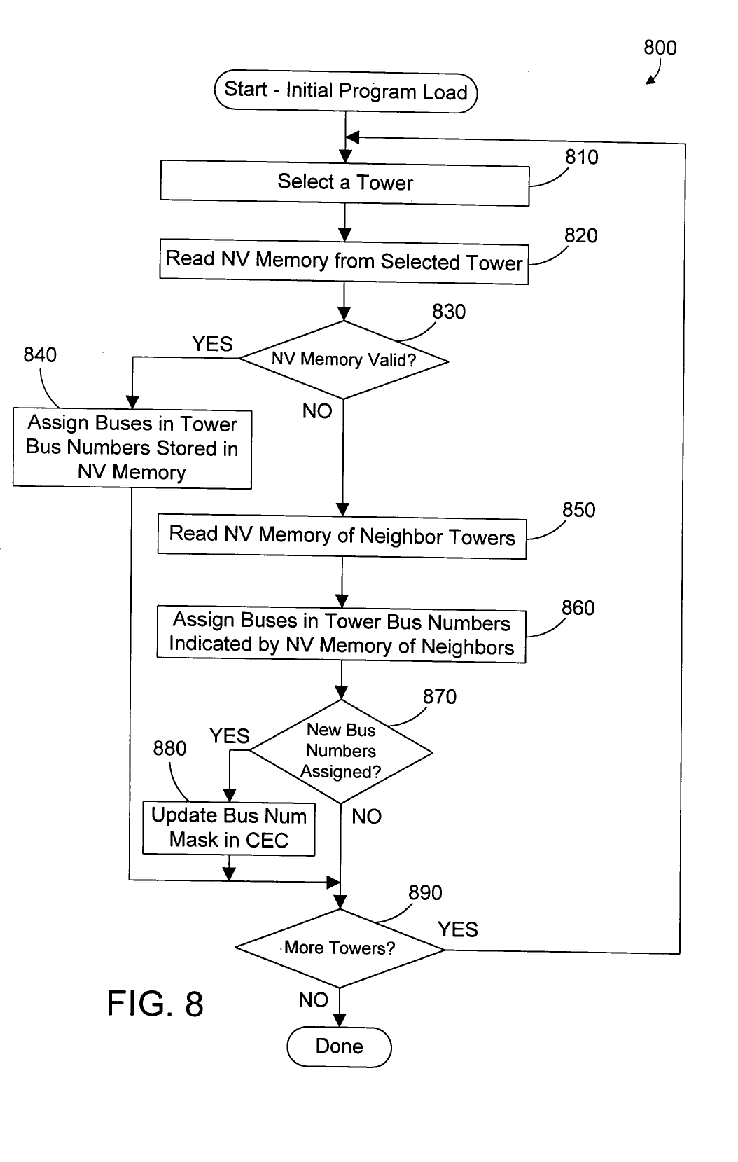

Now we assume the same upgrade is done to Tower C 640 discussed above with reference to FIG. 3, namely that the hardware that includes the tower C NVRAM 642 is replaced, but all the other hardware within Tower C 640 remains unchanged. As shown in FIG. 7, this causes the tower C NVRAM 642 to contain zeroes instead of valid bus numbering information. Referring now to FIG. 8, a method 800 in accordance with the preferred embodiments for the bus number manager to assign bus numbers during initial program load begins by selecting a tower (step 810) the non-volatile memory for that tower is read (step 820). If the data read from the non-volatile memory is valid (step 830=YES), the buses are assigned the bus numbers indicated by the bus numbering information (step 840). However, if the non-volatile memory is not valid (step 830=NO), the non-volatile memory of the neighbor towers are read (step 850). Bus numbers are then assigned based on the bus numbering information that is located in the non-volatile memory of the neighboring towers (step 860). If new bus numbers were assigned in step 860 (step 870=YES), the bus number mask in the CEC NVRAM 112 is updated (step 880) to reflect the newly assigned bus numbers. If no new bus numbers were assigned in step 860 (step 870=NO), step 890 determines whether or not there are more towers to process. If so (step 890=YES), method 800 loops back to step 810 and continues until there are no more towers to process (step 890=NO).

We now apply method 800 in FIG. 8 to the reconfigured system 600 in FIG. 7. We assume that Tower A 620 is initially selected in step 810. The tower A NVRAM 622 is read (step 820), and it is determined that the data read from the tower A NVRAM 622 is valid (step 830=YES). The three buses in Tower A 620 are then assigned bus numbers 1, 2 and 3 (step 840), because the data read from the tower A NVRAM 622 indicates that the first bus number is 1 and the number of buses is 3. There are more towers to process (step 890=YES), so Tower B 630 is then selected in step 810. The tower B NVRAM 632 is read (step 820), and it is determined that the data read from the tower B NVRAM 632 is valid (step 830=YES). The three buses in Tower B 630 are then assigned bus numbers 4, 5 and 6 (step 840), because the data read from the tower B NVRAM 632 indicates that the first bus number is 4 and the number of buses is 3. There are more towers to process (step 890=YES), so Tower C 640 is then selected in step 810. The tower C NVRAM 642 is read (step 820), and it is determined that the data read from the tower C NVRAM 642 is invalid (step 830=NO) because the CEC serial number and CEC type do not match the values stored in the CEC NVRAM 112. At this point the non-volatile memory of the neighbors towers are read (step 850). Thus, step 850 reads the tower B NVRAM 632 and the tower D NVRAM 652. It determines from the contents of these NVRAMs that Tower C 640 has a first bus number of 7 and has three buses. As a result, the three buses in Tower C 640 are assigned bus numbers 7, 8 and 9 (step 860). No new bus numbers were assigned in step 860 (step 870=NO), so no update to the bus number mask is required. There is still one more tower to process (step 890=YES), so method 800 loops back and selects Tower D 650 (step 810). The tower D NVRAM 652 is then read (step 820), and it is determined that the data read is valid (step 830=YES). The buses in Tower D 650 are assigned bus numbers 10 and 11 (step 840), because the data read from the tower D NVRAM 652 indicates that the first bus number is 10 and the number of buses is 2. There are no more towers to process (step 890=NO), so method 800 is done.

The result of processing system 600 in FIG. 7 using method 800 in FIG. 8 is system 600 shown in FIG. 6. In other words, the system 600 has autonomically persisted the bus numbers even though there has been a system reconfiguration. Note that the term “system reconfiguration” herein may include any hardware change that may affect bus numbering, and may also include any change to firmware or other system changes that may affect assignment of bus numbers during initial program load.

The preferred embodiments also include a user interface that may be used to reset bus numbers that are no longer being used. For example, let's assume that the upgrade to Tower C 640 not only upgraded to NVRAM 642, but also added one additional bus. In this case, the old bus numbers of 7, 8 and 9 could not be used because there are now four buses in Tower C 640, and bus 10 h as already been assigned to Tower D 650. As a result, the addition of a fourth bus to Tower C 640 would cause the bus number manager to assign bus numbers 12, 13, 14 and 15 to the buses in Tower C 640. As a result, bus numbers 7, 8 and 9 are no longer in use. Using a user interface, a system administrator could manually reset the bits for bus numbers 7, 8 and 9 in the bus mask in CEC NVRAM 112 to zeroes to indicate these bus numbers may be reused.

At this point, it is important to note that while the present invention has been and will continue to be described in the context of a fully functional computer system, those skilled in the art will appreciate that the bus number manager of the present invention is capable of being distributed as a program product in a variety of forms, and that the present invention applies equally regardless of the particular type of computer readable signal bearing media used to actually carry out the distribution. Examples of suitable signal bearing media include: recordable type media such as floppy disks and CD RW, and transmission type media such as digital and analog communications links.

The autonomic persistent bus numbering achieved by the present invention provides significant advantages in a logically partitioned computer system. Logical partitions typically use bus numbers to record assignment (or “ownership”) of I/O resources to different partition operating systems in a logically partitioned computer system. This includes the assignment and identity of individual I/O bus adapters, which are commonly identified in conjunction with the I/O bus number to which they are connected. Bus numbers are also used to identify and record I/O resources within each partition's operating system configuration databases and in logging I/O errors and service actions. These bus numbers must be persistent over time and over successive logical partition operating system initial program loads. That is, the bus number for a bus must not change from one partition operating system IPL to the next, or the operating system will be unable to identify or locate I/O resources used in previous IPLs. For these reasons, the preferred embodiments provide a solution that autonomically assigns persistent bus numbers even after system reconfiguration, thereby assuring correct operation of a logically partitioned computer system after system reconfiguration without intervention by a system administrator.

Traversing the towers and reading their non-volatile memories allows reconstruction of an interconnection topology database that the bus number manager can use to determine whether and how I/O towers in the system have been reconfigured. Several scenarios are presented below to show the flexibility and versatility in autonomically assigning bus numbers based on the persistent bus numbering information stored in each tower for itself and for its neighbors. The term “hot” refers to changes that occur while the system is running. In a hot change, system code could potentially participate in service operations that change the configuration. Thus, a particular tower, or several towers, could be powered off to perform the reconfiguration or a service operation while the system is still running. The term “cold” refers to changes that occur when the system is powered off and no system code is active.

Missing Tower

To handle missing towers, the bus number manager uses the persistent bus numbering information in the two neighbor towers to determine that a tower is missing. The bus number manager may then cause an error to be posted to an Error Log stating that a tower is missing, or that a cable is missing, whichever the case may be. The non-volatile memory in the two adjacent towers is not changed until either the loop is completed or a tower is powered on in this position. The case where a tower is missing and the loop is complete is treated as a Cold Tower Remove, discussed below under Hot and Cold Tower Remove. The case where a tower was missing and then a new tower is added in its place is discussed below under the Hot and Cold Tower Replace.

Hot and Cold Tower Add

For a Cold Tower Add, the system will power on with a tower that has no or invalid NVRAM data. The data in the existing towers is used to determine that a tower was inserted. New bus numbers are assigned by the bus number manager to this added tower. The data in the neighboring towers' non-volatile memories are updated to reflect the addition of the tower.

For a Hot Tower Add, after the tower is recognized as new, the bus number manager may assign bus numbers in the tower, and the data in the neighboring towers's non-volatile memories are updated to reflect the addition of the new tower. Note that if the added tower has valid bus numbering information for this CEC, this case is handled under the Tower Move case discussed below.

Hot and Cold Tower Replace

To increase tolerance to backplane requirements and tower replacement, the bus number manager will also use the bus numbering information in the two neighboring towers. For the Cold Tower Replace case, if a tower does not have valid bus numbers in its own non-volatile memory, then the bus number manager will query the neighbors' non-volatile memory. If only one of the neighbors' data is valid, then that data is used. If both are invalid, then new bus numbers are assigned by the bus number manager. If both are valid but don't match, then new bus numbers will be requested. In the case of a Hot Tower Replace, the bus number manager may assign bus numbers when the replaced tower appears.

Hot and Cold Tower Move

For a Hot Tower Move, the remove part of moving the tower will be treated the same as a Hot Remove discussed below, and the addition of the tower to the new loop will be treated similar to a Hot Tower Add discussed above. The one difference is that device drivers for the PCI cards in this tower already exist. System software can either move the device drivers from one loop to another, or it can delete the device driver when the tower is removed, and re-create the device driver when the tower is added. For Cold Tower Remove, the tower is simply moved from one RIO loop to another. In this case, on the next IPL the old loop mus repair its next and previous bus numbers in the adjacent towers (same as a Cold Remove), and the new loop must do the same to integrate the new tower, while retaining the same bus number for the moved tower (same as Cold Add).

Hot and Cold Tower Remove

When a tower is Hot Removed, the system code needs to be called as the tower is powered off and removed. This code must remove the device drivers, the PCI host bridges, the PCI buses, and also remove the bus numbers. Then the non-volatile memory in the neighboring towers must be changed to reflect the tower was removed from the RIO loop. When a tower is Cold Removed, the missing tower will be detected on the next IPL. If the loop is complete, the non-volatile memory in the neighboring towers will be changed to reflect the new configuration. If the loop is not complete, this new configuration will be treated as a missing tower, discussed above.

The preferred embodiments provide a significant advance over the prior art by providing bus numbering information in each enclosure for that enclosure and for its neighbor enclosures. Because neighbor enclosures include bus numbering information, the same persistent bus numbers may be reassigned after a system reconfiguration by reading the bus numbering information from the non-volatile memory in the neighbor enclosures. In this manner, the present invention autonomically assigns and persists bus numbers in a computer system that includes multiple physical enclosures. This is an improvement over the prior art persistent bus numbering that stores only information for the buses in an enclosure in the non-volatile memory for that enclosure. The preferred embodiments allow all I/O tower service operations and reconnections to be performed even with the system not running (cold) with no loss of prior bus numbers in use. The preferred embodiments also enable the system to autonomically determine whether previously-defined I/O buses have been reconfigured and to determine when all previously known buses are actually missing or are likely to simply be powered off.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention. For example, while PCI buses are shown as an example of a specific type of bus that may require persistent numbering, other types of buses could also be persistently numbered within the scope of the preferred embodiments.

1. A first apparatus comprising:
a non-volatile memory that contains:
(A) bus numbering information for at least one bus located within the first apparatus; and
(B) bus numbering information for at least one bus located within a second apparatus coupled to the first apparatus.

2. The first apparatus of claim 1 wherein the bus numbering information comprises a beginning bus number and a number of buses.

3. The first apparatus of claim 1 wherein the non-volatile memory comprises at least one identifier for determining if contents of the non-volatile memory are valid.

4. A computer system comprising:
a first physical enclosure;
a second physical enclosure coupled to the first physical enclosure, the second physical enclosure including a non-volatile memory that contains bus numbering information for buses contained in the first and second physical enclosures; and
a bus number manager that detects a change in configuration of the computer system and that reads the bus numbering information from the non-volatile memory for the first and second physical enclosures to determine an appropriate bus number for at least one bus in the first and second physical enclosures.

5. The computer system of claim 4 wherein the bus numbering information comprises a beginning bus number and a number of buses.

6. The computer system of claim 4 wherein the non-volatile memory comprises at least one identifier that is read by the bus number manager to determine if contents of the non-volatile memory are valid.

7. A computer system comprising:
(1) a first physical enclosure comprising:
at least one processor;
a memory coupled to the at least one processor;
a non-volatile memory coupled to the at least one processor, the non-volatile memory including a bus number mask that indicates bus numbers in use in the computer system; and
a hub coupled to the at least one processor;
(2) a second physical enclosure comprising:
at least one bridge coupled to the hub in the first physical enclosure;
at least one numbered bus coupled to the at least one bridge;
a non-volatile memory that contains:
(A) bus numbering information for numbered buses in the second physical enclosure; and
(B) bus numbering information for numbered buses in a third physical enclosure;
(3) the third physical enclosure comprising:
at least one bridge coupled to the at least one bridge in the second physical enclosure;
at least one numbered bus coupled to the at least one bridge in the third physical enclosure;
a non-volatile memory that contains:
(A) bus numbering information for numbered buses in the third physical enclosure; and
(B) bus numbering information for numbered buses in the second physical enclosure;
(4) a bus number manager residing in the memory of the first physical enclosure and executed by the at least one processor in the first physical enclosure, the bus number manager detecting a change in configuration of the computer system and reading the bus numbering information from the non-volatile memory in the second and third physical enclosures to determine an appropriate bus number for at least one bus in the second and third physical enclosures.

8. The computer system of claim 7 wherein the bus numbering information comprises a beginning bus number and a number of buses.

9. A computer-implemented method for storing bus numbering information in a non-volatile memory, the method comprising the steps of:
assigning unique bus numbers to buses in a first physical enclosure;
assigning unique bus numbers to buses in a second physical enclosure; and
storing the bus numbers for the buses in the first and second physical enclosures in the non-volatile memory.

10. The method of claim 9 wherein the non-volatile memory resides in the first physical enclosure.

11. The method of claim 9 wherein the bus numbering information comprises a beginning bus number and a number of buses.

12. A computer-implemented method for numbering a plurality of buses in a computer system that includes a plurality of physical enclosures, the method comprising the steps of:
storing in a non-volatile memory bus numbering information for at least one bus in a first physical enclosure;
storing in the non-volatile memory bus numbering information for at least one bus in a second physical enclosure;
detecting a change in the computer system configuration; and
reading the bus numbering information from the non-volatile memory for the first and second physical enclosures to determine an appropriate bus number for at least one bus in the first and second physical enclosures.

13. The method of claim 12 wherein the bus numbering information comprises a beginning bus number and a number of buses.

14. A computer-implemented method for assigning and maintaining persistent numbers to a plurality of buses in a computer system that includes a plurality of physical enclosures, the method comprising the steps of:
assigning unique bus numbers to buses in a first physical enclosure;
assigning unique bus numbers to buses in a second physical enclosure coupled to the first physical enclosure;
storing bus numbering information corresponding to the bus numbers for the buses in the first and second physical enclosures in a first non-volatile memory in the first physical enclosure;
storing bus numbering information corresponding to the bus numbers for the buses in the first and second physical enclosures in a second non-volatile memory in the second physical enclosure;
detecting a change in the computer system configuration;
reading the bus numbering information from the first and second non-volatile memories to determine an appropriate bus number for the buses in the first physical enclosure; and
reading the bus numbering information from the first and second non-volatile memories to determine an appropriate bus number for the buses in the second physical enclosure.

15. The method of claim 14 wherein the bus numbering information comprises a beginning bus number and a number of buses.

16. A program product comprising:
a bus number manager that detects a change in configuration of a computer system that includes a plurality of physical enclosures, the bus number manager reading bus numbering information from a non-volatile memory in a first physical enclosure to determine an appropriate bus number for at least one bus in the first physical enclosure and at least one bus in a second physical enclosure; and
computer readable signal bearing media bearing the bus number manager.

17. The program product of claim 16 wherein the signal bearing media comprises recordable media.

18. The program product of claim 16 wherein the signal bearing media comprises transmission media.

19. The program product of claim 16 wherein the bus numbering information comprises a beginning bus number and a number of buses.

20. The program product of claim 16 wherein the non-volatile memory comprises at least one identifier that is read by the bus number manager to determine if contents of the non-volatile memory are valid.
